(19) United States
(12) Patent Application Publication
(10) Pub. No.: US 2011/0008664 A1
(43) Pub. Date: Jan. 13, 2011

(54) INPUT APPARATUS

(76) Inventor: Tien-Chuan Chen, Taoyuan (TW)

Correspondence Address: NORTH AMERICA INTELLECTUAL PROPERTY CORPORATION, P.O. BOX 506, MERRIFIELD, VA, 22116, US

(21) Appl. No.: 12/831,266

(22) Filed: Jul. 7, 2010

(30) Foreign Application Priority Data
Jul. 7, 2009 (TW) 098212333

(51) Int. Cl. H01M 2/10

(52) U.S. Cl. 429/97

(57) ABSTRACT

An input apparatus includes a main body and a battery holding member. The main body has at least one battery slot. The battery holding member includes a rotation shaft and a holding arm connected to the rotation shaft. The holding arm is disposed over the at least one battery slot, and the rotation shaft is rotatably connected to the main body such that the holding arm is rotatable relative to the main body. The holding arm is capable of crossing into the at least one battery slot selectively by rotating the rotation shaft.

### BACKGROUND OF THE INVENTION

1. Field of the Invention

The invention relates to an input apparatus and, more particularly, to an input apparatus capable of preventing a battery from dropping out of a battery slot.

2. Description of the Prior Art

Generally speaking, a wireless mouse is mainly powered by a battery installed in it. The wireless mouse has a battery slot for a user to install the battery. A conventional battery slot has a metal clip. A force needs to be applied on the battery for pressing the metal clip such that the battery can be disposed into the battery slot, and the metal clip contacts against the battery by a resilient force.

However, the battery drops out easily from the battery slot when great vibration is applied on the wireless mouse or after an elasticity of the metal clip vanishes gradually. Accordingly, the wireless mouse will lose power supply source, and it will make a great inconvenience for the user.

Therefore, an objective of the invention is to provide an input apparatus capable of preventing a battery from dropping out of a battery slot, such that the aforesaid problems can be solved.

### SUMMARY OF THE INVENTION

An objective of the invention is to provide an input apparatus. In practical application, a computer mouse can be illustrated for the input apparatus.

According to one embodiment of the invention, the input apparatus comprises a main body and a battery holding member. The main body has at least one battery slot, and the battery holding member comprises a rotation shaft and a holding arm connected to the rotation shaft. In this embodiment, the holding arm is connected to an end of the rotation shaft, and the holding arm extends radially outward from the rotation shaft.

The holding arm is disposed over the at least one battery slot, and the rotation shaft is rotatably connected to the main body such that the holding arm is rotatable relative to the main body. The holding arm is capable of crossing into the at least one battery slot selectively by rotating the rotation shaft.

In practical application, the main body may have two battery slots, and a center of the holding arm is connected to an end of the rotation shaft such that both ends of the holding arm extend radially outward from the rotation shaft. Accordingly, the both ends of the holding arm are capable of crossing into the two battery slots respectively and selectively by rotating the rotation shaft.

In this embodiment, the main body has a hole, and an end of the rotation shaft has an engaging portion. The end of the rotation shaft is inserted into the hole such that the engaging portion is engaged with a surface adjacent to the hole. Because the engaging portion is engaged with the surface adjacent to the hole, the rotation shaft is rotatable such that the holding arm is capable of rotating relative to the main body. According to a preferred embodiment of the invention, at least one radial opening is formed on a periphery of the engaging portion such that the end of the rotation shaft can be inserted into the hole easily.

According to another embodiment of the invention, the main body has a hole, and a screw and a washer are disposed in the hole. The end of the rotation shaft is inserted into the hole, and the screw is passed through the washer and is fixed in the screw hole. Accordingly, the rotation shaft is rotatably connected to the main body such that the holding arm is capable of rotating relative to the main body.

Furthermore, according to another embodiment of the invention, the holding arm has a positioning hole. The main body comprises a resilient beam, and an end of the resilient beam has a positioning protrusion adapted to cooperate with the positioning hole. When the holding arm crosses into the battery slot by rotating the rotation shaft, the positioning protrusion can move relative to the holding arm along a lower surface of the holding arm until the positioning protrusion is limited in the positioning hole, whereby the holding arm can stably stay in the battery slot.

Furthermore, the input apparatus of the invention may further comprise a cover for covering the main body. According to one embodiment of the invention, the cover has a magnetic member, and the main body comprises a magnetic induction member capable of attracting the magnetic member. The holding arm crosses into the battery slot when the holding arm is rotated to a close position. The magnetic induction member is blocked by the holding arm when the holding arm is rotated to an open position, such that the magnetic member cannot attract the magnetic induction member. Consequently, the cover can be covered on the main body.

According to another embodiment of the invention, the cover has a magnetic induction member, and the main body comprises a magnetic member capable of attracting the magnetic induction member. The holding arm crosses into the battery slot when the holding arm is rotated to a close position. The magnetic member is blocked by the holding arm when the holding arm is rotated to an open position, such that the magnetic member cannot attract the magnetic induction member. Consequently, the cover can be covered on the main body.

In summary, the battery holding member of the input apparatus of the invention is capable of preventing a battery from dropping out of a battery slot. The battery can be placed into the battery slot when the holding arm of the battery holding member is rotated to the open position. Then, the holding arm of the battery holding member is rotated to the close position so as to make the holding arm cross into the battery slot, such that the holding arm can contact against the battery for preventing the battery from dropping out.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exploded diagram illustrating an input apparatus according to one embodiment of the invention.

FIG. 2 is a schematic diagram illustrating that the holding arm of the battery holding member is rotated to an open position.

FIG. 3 is a schematic diagram illustrating that the holding arm of the battery holding member is rotated to a close position.

FIG. 4 is a schematic diagram illustrating that the positioning protrusion of the resilient beam is limited in the positioning hole 128 of the holding arm 120.

### DETAILED DESCRIPTION

An objective of the invention is to provide an input apparatus equipped with a battery holding member capable of preventing a battery from dropping out of a battery slot. In practical application, the input apparatus can be a computer mouse and will be described as the following illustrated embodiments.

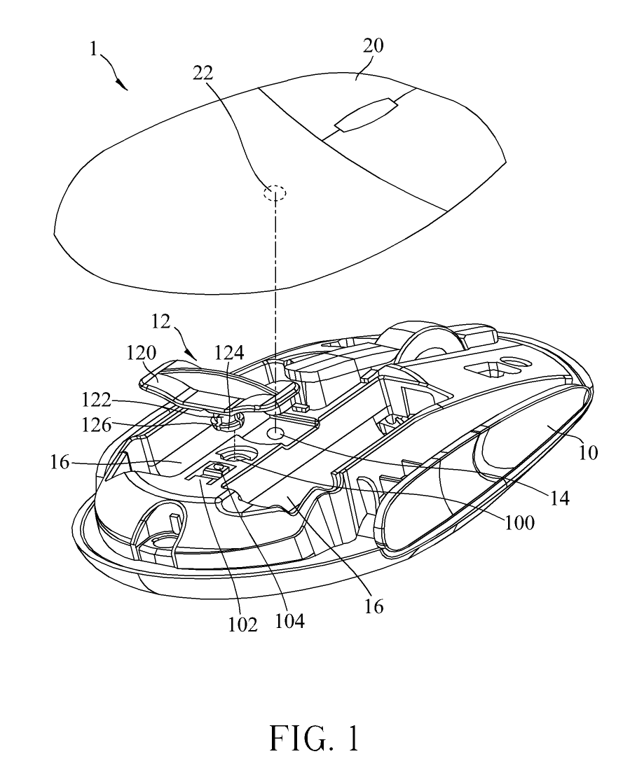

Referring to FIG. 1, FIG. 1 is an exploded diagram illustrating an input apparatus 1 according to one embodiment of the invention. As shown in FIG. 1, the input apparatus 1 comprises a main body 10 and a battery holding member 12. The main body 10 has at least one battery slot 16 (two battery slots 16 are illustrated in FIG. 1), and the battery holding member 12 comprises a rotation shaft 122 and a holding arm 120 connected to the rotation shaft 122.

In one embodiment, the holding arm 120 is connected to an end of the rotation shaft 122, and the holding arm 120 extends radially outward from the rotation shaft 122. Furthermore, as shown in FIG. 1, a center of the holding arm 120 is connected to an end of the rotation shaft 122 such that both ends of the holding arm 120 extend radially outward from the rotation shaft 122 and are symmetric to each other relative to the center of the rotation shaft 122.

The holding arm 120 is disposed over the two battery slots 16, and the rotation shaft 122 is rotatably connected to the main body 10 such that the holding arm 120 is rotatable relative to the main body 10. Accordingly, both ends of the holding arm 120 are capable of crossing into the two battery slots 16 selectively by rotating the rotation shaft 122.

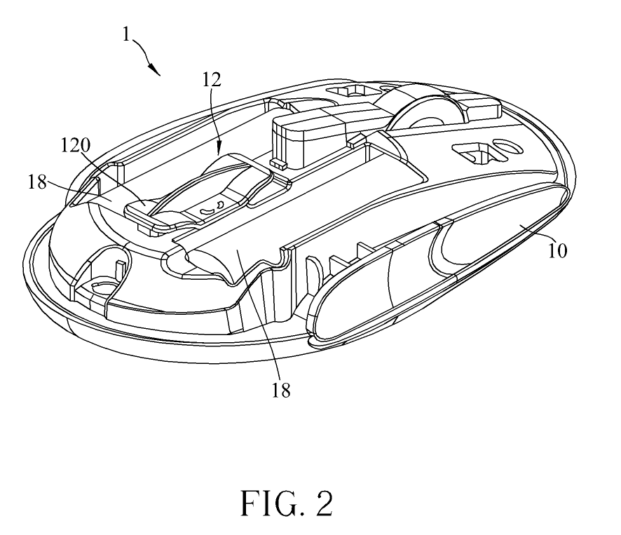

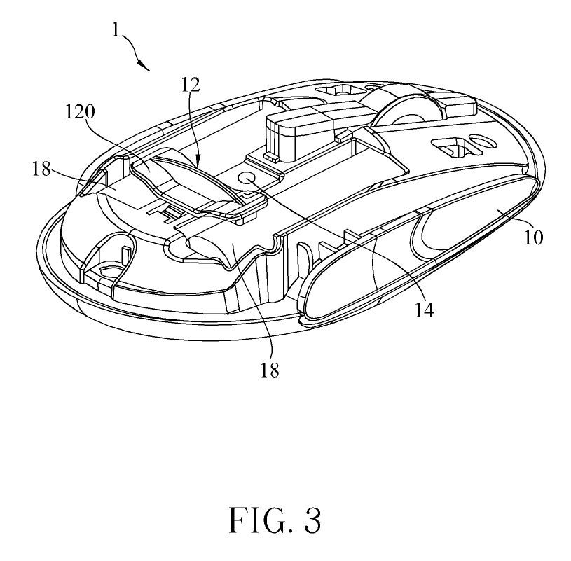

Referring to FIG. 2 and FIG. 3, FIG. 2 is a schematic diagram illustrating that the holding arm 120 of the battery holding member 12 is rotated to an open position, and FIG. 3 is a schematic diagram illustrating that the holding arm 120 of the battery holding member 12 is rotated to a close position.

As shown in FIG. 2, when the holding arm 120 of the battery holding member 12 is rotated to the open position, two batteries 18 can be installed in two battery slots 16 respectively because the holding arm 120 does not cross into the two battery slots 16. After the batteries 18 are installed in the battery slots 16, the holding arm 120 of the battery holding member 12 can be rotated to the close position (as shown in FIG. 3). In the meanwhile, both ends of the holding arm 120 cross into the two battery slots 16 so as to support the batteries 18 and prevent them from dropping out of the battery slots 16.

As shown in FIG. 1, in another embodiment, the main body 10 has a hole 100, and an end of the rotation shaft 122 has an engaging portion 124. The end of the rotation shaft 122 is inserted into the hole 100 such that the engaging portion 124 is engaged with a surface adjacent to the hole 100. Because the engaging portion 124 is engaged with the surface adjacent to the hole 100, the rotation shaft 122 is rotatable such that the holding arm 120 is capable of rotating relative to the main body 10. In one preferred embodiment, at least one radial opening 126 is formed on a periphery of the engaging portion 124 and used to compress the engaging portion 124, so as to reduce its volume. Accordingly, the end of the rotation shaft 122 can be inserted into the hole 100 more easily.

In another embodiment, a screw and a washer may be disposed in the hole 100, and an end of the rotation shaft 122 may have a screw hole. The end of the rotation shaft 122 is inserted into the hole 100, and the screw is passed through the washer and is fixed in the screw hole. Accordingly, the rotation shaft 122 is rotatably connected to the main body 10 such that the holding arm 120 is capable of rotating relative to the main body 10.

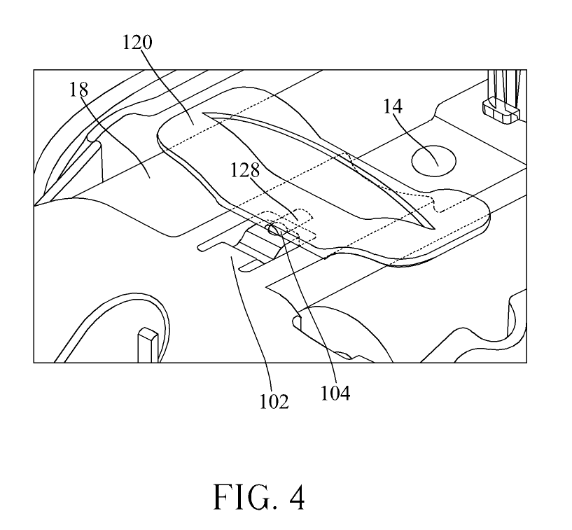

Please refer to FIG. 4. In another embodiment, the holding arm 120 has a positioning hole 128. The main body 10 comprises a resilient beam 102, and an end of the resilient beam 102 has a positioning protrusion 104 adapted to cooperate with the positioning hole 128. FIG. 4 is a schematic diagram illustrating that the positioning protrusion 104 of the resilient beam 102 is limited in the positioning hole 128 of the holding arm 120.

When the holding arm 120 crosses into the battery slot 16 by rotating the rotation shaft 122 and after a periphery of the holding arm 120 contacts the positioning protrusion 104, the holding arm 120 can move over the positioning protrusion 104 along the contour of the positioning protrusion 104, and the positioning protrusion 104 can move relative to the holding arm 120 along a lower surface of the holding arm 120 until the positioning protrusion 104 is limited in the positioning hole 128. Accordingly, both ends of the holding arm 120 can stably stay in the battery slot 16 such that the battery can be supported by the holding arm 120.

Furthermore, when the holding arm 120 is rotated from the close position to the open position, the positioning protrusion 104 limited in the positioning hole 128 can get out from the positioning hole 128 by applying a moment on the holding arm 120. With the rotation of the holding arm 120, the positioning protrusion 104 can move relative to the holding arm 120 along the lower surface of the holding arm 120 until the positioning protrusion 104 gets out of the periphery of the holding arm 120. Afterward, the holding arm 120 can be rotated continuously to the open position. Accordingly, the battery 18 can be installed into or uninstalled from the battery slot 16.

Furthermore, as shown in FIG. 1, the input apparatus 1 of the invention can further comprise a cover 20 for covering the main body 10. The cover 20 can cover the battery slot 16 of the input apparatus 1.

In one embodiment, the cover 20 may have a magnetic member 22, and the main body 10 may comprise a magnetic induction member 14 capable of attracting the magnetic member 22. In practical application, the magnetic member 22 can be made of magnetic material such as magnet and so on, and the magnetic induction member 14 can be made of material capable of being magnetized such as metal and so on.

When the holding arm 120 is rotated to the close position, both ends of the holding arm 120 cross into the two battery slots (as shown in FIG. 3) . Because the magnetic induction member 14 on the input apparatus 1 is exposed, the magnetic member 22 and the magnetic induction member 14 can attract each other by covering the cover 20 on the main body 10, such that the cover 20 can be fixed on the main body 10.

However, when the holding arm 120 is rotated to the open position (as shown in FIG. 2), the battery is allowed to be installed into or uninstalled from the battery slot. Since the magnetic induction member 14 is blocked by the holding arm 120, the magnetic member 22 cannot attract the magnetic induction member 14. Accordingly, the cover 20 can not cover the main body 10. Only when the holding arm 120 is rotated to the close position and the magnetic induction member 14 is exposed, the cover 20 can be covered on the main body 10.

As mentioned above, once the battery is not completely installed or uninstalled yet and before the holding arm 120 is rotated to the close position, the cover 20 is not allowed to be covered on the main body 10. In other words, an objective of such design is to provide a fool-proof function. Only after the battery is completely installed or uninstalled and the holding arm 120 is rotated to the close position, the magnetic induction member 14 is exposed and then the cover 20 can be covered on the main body 10. Accordingly, the magnetic member 22 attracts the magnetic induction member 14 such that the cover 20 is fixed on the main body 10.

In another embodiment, the position where the magnetic induction member is disposed and the position where the magnetic member is disposed can be exchanged. In other words, the cover 20 may have the magnetic induction member (such as metal), and the main body 10 may comprise the magnetic member (such as magnet) capable of attracting the magnetic induction member.

In this embodiment, when the holding arm 120 is rotated to the close position, both ends of the holding arm 120 cross into the two battery slots 16. Because the magnetic induction member on the main body 10 of the input apparatus 1 is exposed, the magnetic member and the magnetic induction member attract each other such that the cover 20 can be fixed on the main body 10. However, when the holding arm 120 is rotated to the open position, the magnetic member 22 on the main body 10 of the input apparatus 1 is blocked by the holding arm 120 such that the magnetic induction member on the cover 20 cannot attract the magnetic member. Accordingly, the cover 20 can not cover the main body 10.

In summary, the battery holding member of the input apparatus of the invention is capable of preventing a battery from dropping out of a battery slot. The battery can be placed into the battery slot when the holding arm of the battery holding member is rotated to the open position. Then, the holding arm of the battery holding member is rotated to the close position so as to make the holding arm cross into the battery slot, such that the holding arm can contact against the battery for preventing the battery from dropping out. Furthermore, the battery holding member can provide the fool-proof function. When the holding arm of the battery holding member is rotated to the close position, the cover is allowed to be covered on the main body. When the holding arm of the battery holding member is rotated to the open position, the cover is not allowed to be covered on the main body.

Those skilled in the art will readily observe that numerous modifications and alterations of the device and method may be made while retaining the teachings of the invention.

What is claimed is:

1. An input apparatus comprising:
a main body having at least one battery slot; and
a battery holding member comprising a rotation shaft and a holding arm connected to the rotation shaft, the holding arm being disposed over the at least one battery slot, and the rotation shaft being rotatably connected to the main body such that the holding arm is rotatable relative to the main body, the holding arm being capable of crossing into the at least one battery slot selectively by rotating the rotation shaft.

2. The input apparatus of claim 1, wherein the main body has a hole, an end of the rotation shaft has an engaging portion, and the end of the rotation shaft is inserted into the hole such that the engaging portion is engaged with a surface adjacent to the hole.

3. The input apparatus of claim 2, wherein at least one radial opening is formed on a periphery of the engaging portion.

4. The input apparatus of claim 1, wherein the main body has a hole, a screw and a washer are disposed in the hole, an end of the rotation shaft has a screw hole, the end of the rotation shaft is inserted into the hole, and the screw is passed through the washer and is fixed in the screw hole.

5. The input apparatus of claim 1, wherein the holding arm is connected to an end of the rotation shaft, and the holding arm extends radially outward from the rotation shaft.

6. The input apparatus of claim 1, wherein the main body has two battery slots, a center of the holding arm is connected to an end of the rotation shaft such that both ends of the holding arm extend radially outward from the rotation shaft, the both ends of the holding arm are capable of crossing into the two battery slots respectively and selectively by rotating the rotation shaft.

7. The input apparatus of claim 1, wherein the holding arm has a positioning hole, the main body comprises a resilient beam, and an end of the resilient beam has a positioning protrusion adapted to cooperate with the positioning hole, when the holding arm crosses into the battery slot by rotating the rotation shaft, the positioning protrusion is limited in the positioning hole.

8. The input apparatus of claim 1, further comprising a cover for covering the main body, the cover having a magnetic member, the main body comprising a magnetic induction member capable of attracting the magnetic member, wherein the holding arm crosses into the battery slot when the holding arm is rotated to a close position, and the magnetic induction member is blocked by the holding arm when the holding arm is rotated to an open position.

9. The input apparatus of claim 1, further comprising a cover for covering the main body, the cover having a magnetic induction member, the main body comprising a magnetic member capable of attracting the magnetic induction member, wherein the holding arm crosses into the battery slot when the holding arm is rotated to a close position, and the magnetic member is blocked by the holding arm when the holding arm is rotated to an open position.
